(19) United States
(12) Patent Application Publication
(10) Pub. No.: US 2025/0276451 A1
(43) Pub. Date: Sep. 4, 2025

(54) FRYING ROBOT

(71) Applicant: LG ELECTRONICS INC., Seoul (KR)

(72) Inventors: Kwangyong UM, Seoul (KR); Heenam PARK, Seoul (KR)

(73) Assignee: LG ELECTRONICS INC., Seoul (KR)

(21) Appl. No.: 18/701,374

(22) PCT Filed: Mar. 29, 2022
(86) PCT No.: PCT/KR2022/004412

§ 371 Date: Oct. 1, 2024

(30) Foreign Application Priority Data
Oct. 15, 2021 (KR) 10-2021-0137341

(51) Int. Cl. B25J 11/00; A47J 37/12; B25J 9/02; B25J 15/08

(52) U.S. Cl. CPC B25J 11/0045; A47J 37/1266; A47J 37/1295; B25J 9/026; B25J 15/08

(57) ABSTRACT

A frying robot according to the present embodiment may comprise: a frame; a robot mechanism installed on the frame; and a gripper connected to the robot mechanism. The gripper may comprise: a pair of fingers for gripping an extension portion of a cooking tool; and a finger-driving mechanism which moves the pair of fingers in a direction close to or away from each other. At least one of the pair of fingers may comprise: a finger body having an insertion groove portion formed therein, in which a bent portion of the extension portion is inserted; and a fixing guide protruding from the insertion groove portion and supporting the bent portion.

### TECHNICAL FIELD

The present invention relates to a robot that is capable of cooking ingredients, and more particularly, to a frying robot that is capable of frying ingredients.

### BACKGROUND ART

A robot is a machine that automatically processes or operates a given task based on its own abilities. The application fields of robots may be broadly classified into industrial, medical, space, underwater, etc., and may be used in a variety of fields.

In recent, the number of cooking robots that are capable of performing cooking using robots is gradually increasing, and an example of a robot comprises an automatic frying device disclosed in Korean Patent Publication No. 10-2004-0070450 A (published on Aug. 9, 2004). The automatic frying device comprises: a main body in which one or more sauce containers containing sauce (or flour) and at least one oil container installed to be provided with a heater for heating an oil are installed at an upper portion, and a guide groove is defined in a horizontal direction; a horizontal moving portion including a first motor installed in the main body and a horizontal movable bracket that is reciprocated in the horizontal direction by the first motor; a vertical moving part including a second motor installed on the horizontal movable bracket and a vertical movable bracket vertically elevated the second motor; and a chicken skewer portion including a vertical support that is coupled to the vertical movable bracket to pass through the guide grove so as to protrude to an upper side of the main body, an extension support that is coupled to an end of the vertical support at an upper portion of the main body to extends forward, a plurality of hooks extending downward from the extension support, and a skewer that is detachably hung on the hooks and passes through a chicken.

Another example of the robot is disclosed in a robot system and a method for the same, which are disclosed in Korean Patent Publication No. 10-2019-0112679 A (published on Oct. 7, 2019), and the robot system comprises a robot arm that tilts a frying net in a first direction or tilts or elevates the frying net in a second direction different from the first direction; and a controller that implements a debris removal mode in which the robot arm moves and rotates the frying net to a set debris removal path through debris inside the fryer is filtered.

### DISCLOSURE OF THE INVENTION

### Technical Problem

The present embodiment provides a frying robot that is capable of griping a cooking tool with high stability and reliability and cooking ingredients safely.

### Technical Solution

A frying robot according to the present embodiment may comprise: a frame; a robot mechanism installed on the frame; and a gripper connected to the robot mechanism.

The gripper may comprise: a pair of fingers for gripping an extension portion of a cooking tool; and a finger-driving mechanism which moves the pair of fingers in a direction close to or away from each other.

At least one of the pair of fingers may comprise: a finger body having an insertion groove portion formed therein, in which a bent portion of the extension portion is inserted; and a fixing guide protruding from the insertion groove portion and supporting the bent portion.

The finger body may comprise: a main body portion; an upper body portion protruding from an upper portion of the main body portion and spaced apart from the fixing guide in a vertical direction; and a side body portion protruding from the main body portion and spaced apart from the fixing guide in a left and right direction.

An upper chamfer configured to assist an insertion of the bent portion may be provided on the upper body portion.

The fixing guide may protrude from the main body portion.

A lower chamfer configured to assist an insertion of the bent portion may be provided on the fixing guide.

The finger-driving mechanism may comprise: a pair of moving shafts; a first finger bracket connected to one of the pair of moving shafts and one of the pair of fingers; and a second finger bracket connected to the other one of the pair of moving shafts and the other one of the pair of fingers.

The robot mechanism may comprise: a first robot moving along the frame; and a second robot disposed to be elevatable on the first robot, wherein the finger-driving mechanism may be connected to the second robot.

The second robot may comprise: a motor; a ball screw connected to the motor; and an outer cover configured to cover the ball screw.

The outer cover may comprise: a center body; a front body bent from a front end of the center body; and a rear body bent from a rear end of the center body.

The frame may comprise: a vertical frame; a horizontal frame disposed above the vertical frame; and a reinforcement bracket coupled to each of the vertical frame and the horizontal frame.

A moving guide configured to guide movement of the robot mechanism may be disposed on the horizontal frame.

The frying robot may further comprise: a preparation table disposed on the frame to accommodate a body of the cooking tool; a completion table disposed on the frame to be spaced apart from the first table and configured to accommodate the body of the cooking tool; and at least one fryer disposed between the preparation table and the completion table and having a space into which the body of the cooking tool is inserted.

The frying robot may further comprise an emergency switch configured to stop the robot mechanism.

The frying robot may further comprise a display configured to display a cooking time of the fryer in progress.

The frying robot may further comprise a controller configured to control the robot mechanism, the finger-driving mechanism, and the fryer.

The controller may be configured to control the robot mechanism so that the cooking tool is shaken at least once during the cooking by the fryer.

Another example of the frying robot comprises: a pair of fingers configured to grip an extension portion of a cooking tool; a finger-driving mechanism configured to move the pair of fingers in a direction close to or away from each other, wherein at least one of the pair of fingers comprises: a finger body having an insertion groove portion defined therein, into which a bent portion of the extension portion is inserted; and a fixing guide protruding from the insertion groove portion to support the bent portion.

The finger body may comprise: a main body portion; an upper body portion protruding from an upper portion of the main body portion and spaced apart from the fixing guide in a vertical direction; and a side body portion protruding from the main body portion and spaced apart from the fixing guide in a left and right direction.

An upper chamfer configured to assist an insertion of the bent portion may be provided on the upper body portion.

The fixing guide may protrude from the main body portion.

A lower chamfer configured to assist an insertion of the bent portion may be provided on the fixing guide.

### Advantageous Effects

According to the present embodiment, the bent portion of the cooking tool may be stably supported between the finger body and the fixing guide to minimize the sliding of the cooking tool and grip the cooking tool with the stability.

In addition, the gripper may stably support the cooking tool in the two directions to minimize the shaking of the cooking tool, quickly move the cooking tool, and safely and quickly perform the cooking.

In addition, the upper chamfer of the upper body portion may assist the extension portion to enter the insertion groove portion and minimize the malfunction of the gripper.

In addition, the lower chamfer of the fixing guide may assist the extension portion to be inserted into the insertion groove portion and minimize the malfunction of the gripper.

In addition, the internal configuration of the second robot may be shielded by the front body and the rear body, which are disposed on the outer cover of the second robot to improve the aesthetics and maintain and cleaning of the fryer.

In addition, the shaking of the frame may be minimized by the reinforcement bracket, and thus, the robot mechanism may more stably operate.

In addition, the user may press the emergency switch to quickly stop the robot mechanism, thereby improving the safety.

In addition, the user may prepare the ingredients while looking at the display to enable the faster and more convenient cooking.

In addition, the cooking tool may be shaken during the cooking operation using the fryer to minimize the clumping of the ingredients.

### BRIEF DESCRIPTION OF THE DRAWINGS

FIG. 1 is a perspective view of a frying robot according to the present embodiment.

FIG. 2 is a plan view of the frying robot according to the present embodiment.

FIG. 3 is a side view of the frying robot according to the present embodiment.

FIG. 4 is a perspective view of a cooking tool used in the frying robot according to the present embodiment.

FIG. 5 is a view when the frying robot carries the cooking tool according to the present embodiment.

FIG. 6 is a perspective view illustrating the inside of a second robot according to the present embodiment.

FIG. 7 is a perspective view before a gripper grips the cooking tool according to the present embodiment.

FIG. 8 is a perspective view when the gripper completely grips the cooking tool according to the present embodiment.

FIG. 9 is a perspective view of a frame according to the present embodiment.

FIG. 10 is a view of a display according to the present embodiment.

FIG. 11 is a view of a terminal according to the present embodiment.

FIG. 12 is a control block diagram according to the present embodiment.

FIG. 13 is a flowchart illustrating an operation of a frying robot according to the present embodiment.

### MODE FOR CARRYING OUT THE INVENTION

Hereinafter, detailed embodiments will be described in detail with reference to the accompanying drawings.

Hereinafter, when an element is described as being “coupled” or “connected” to another element, it means that the two elements are directly coupled or connected, or a third element exists between the two elements, and the two elements are coupled or connected to each other by the third element. On the other hand, the “direct coupling” or “direct connecting” of one element to the other element may be understood that the third element does not exist between the two elements.

A robot may refer to a machine that automatically processes or operates a given task by its own ability. In particular, a robot having a function of recognizing an environment and performing a self-determination operation may be referred to as an intelligent robot.

An example of a robot may be a cooking robot, particularly a frying robot. Hereinafter, the frying robot will be described with reference numeral 10a.

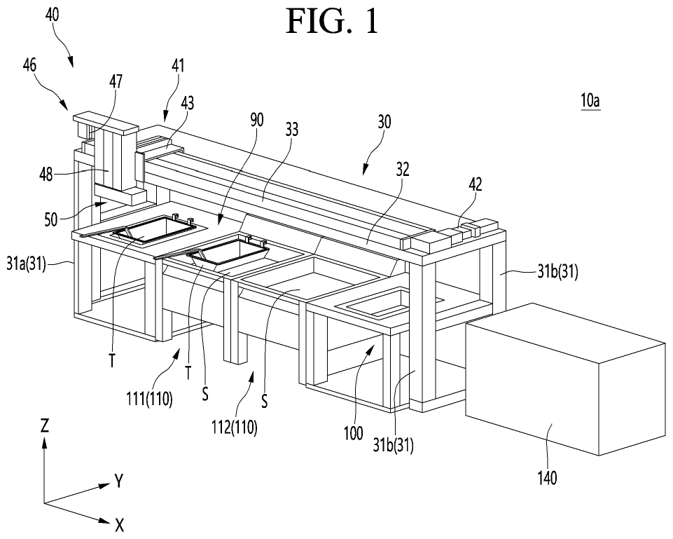

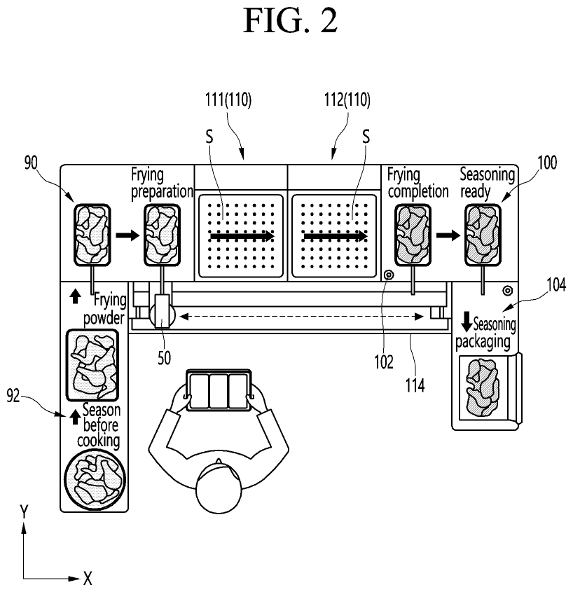

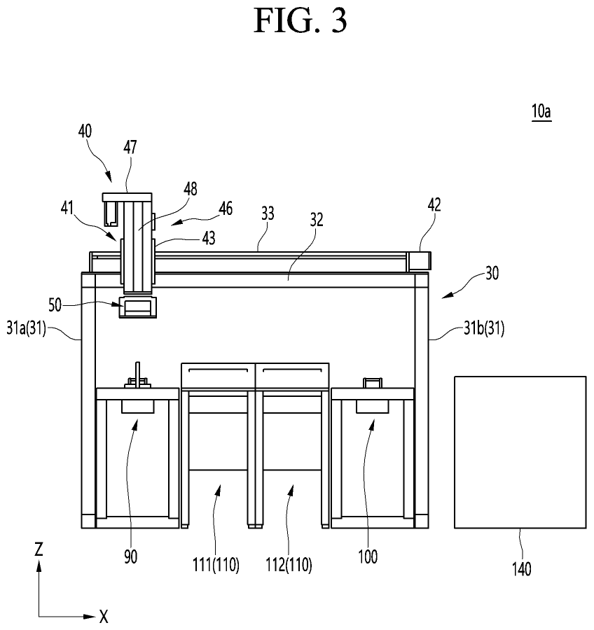

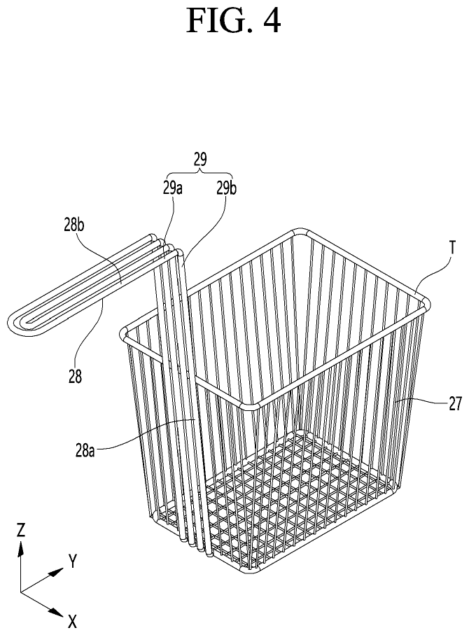

FIG. 1 is a perspective view of a frying robot according to the present embodiment, FIG. 2 is a plan view of the frying robot according to the present embodiment, FIG. 3 is a side view of the frying robot according to the present embodiment, and FIG. 4 is a perspective view of a cooking tool used in the frying robot according to the present embodiment.

The frying robot 10a may comprise a frame 30, a robot mechanism 40, and a gripper 50. The frying robot 10a may cook fried food and may further comprise a preparation table 90, a completion table 100, and a fryer 110.

The frying robot 10a may grip a cooking tool T disposed on the preparation table 90 to insert the cooking tool T into the fryer 110, and feed ingredients such as raw chicken or potatoes contained in the cooking tool T may be fried in the fryer 110 in a state of being contained in the cooking tool T. When the fryer 110 completes the cooking the ingredients, the frying robot 10a may grip the cooking tool T again and take the cooking tool T out of the fryer 110. The frying robot 10a may move the cooking tool T to the completion table 100.

An example of the cooking tool T may comprise a body 27 and an extension portion 28 extending from the body 27, as illustrated in FIG. 4.

The body 27 may accommodate ingredients such as raw chicken or potatoes and may be provided in a three-dimensional shape. An example of the body 27 may be a frame. A plurality of openings may be defined in the frame, and an oil in the fryer 110 may flow into the inside of the frame through the plurality of openings, and an oil inside the frame may flow out of the frame through the plurality of openings.

The extension portion 28 may be provided to protrude from the body 27 and may not be inserted into the fryer 110.

A handle portion may be provided on the extension portion 28.

A bent portion 29 may be provided at one side of the extension portion 28. The extension portion 28 may comprise a first extension portion 28a, a bent portion 29, and a second extension portion 28b.

The first extension portion 28a may extend from the body 27.

One end of the bent portion 29 may extend from the first extension portion 28a.

The second extension portion 28b may extend from the bent portion 29.

An upper portion 29a of the bent portion 29 may be bent perpendicular to a lower portion 29b of the bent portion 29, and the upper portion 29a of the bent portion 29 may be bent at a right angle to the lower portion 29b of the bent portion 29 and may also be bent to have an obtuse inclination angle.

The lower portion 29b of the bent portion 29 may extend upward from the first extension portion 28a.

The second extension portion 28b may extend horizontally or obliquely from the upper portion 29a of the bent portion 29.

As illustrated in FIG. 1, the frame 30 may be disposed to be elongated in a forward and backward direction X. The frame 30 may support the robot mechanism 40.

The frame 30 may comprise a vertical frame 31 and a horizontal frame 32 disposed above the vertical frame 31.

The vertical frame 31 may be provided in plurality. The vertical frame 31 may comprise a front frame 31a in a material movement direction and a rear frame 31b disposed behind the front frame 31a.

The front frame 31a and the rear frame 31b may be spaced apart from each other in the forward and backward direction X.

The front frame 31a may be provided in a pair, and the pair of front frames 31a may be spaced apart from each other in a left and right direction Y.

The rear frame 31b may be provided in a pair, and the pair of rear frames 31b may be spaced apart from each other in the left and right direction Y.

The horizontal frame 32 may be provided to be elongated in a longitudinal direction X of the frame 30.

The horizontal frame 32 may be provided in plurality.

A movement guide 33 that guides movement of the robot mechanism 40 may be disposed on the horizontal frame 32. The movement guide 33 may be disposed on an upper portion of the horizontal frame 32. The movement guide 33 may be provided to be elongated in the longitudinal direction X of the frame 30.

The robotic mechanism 40 may be disposed on the frame 30.

An example of the robotic mechanism 40 may be a Cartesian type robot. The robot mechanism 40 may also be provided as a cylindrical type robot or a Scara robot. When the robot device 30 is an articulated robot mechanism such as the Scara robot, a structure of the articulated robot may be complicated and expensive, and thus, it may be preferable to be provided as a cheaper robot than the articulated robot mechanism.

The robotic mechanism 30 may be provided as a robot with two degrees of freedom and may move along the frame 30 in the longitudinal direction X of the frame 30 and be preferably elevated in a vertical direction Z.

The robotic mechanism 40 may comprise a first robot 41 that moves along the frame 30 and a second robot 46 disposed to be elevatable on the first robot 41.

The first robot 41 may be a robot that moves in the longitudinal direction X of the frame 30 and may be an X-axis robot.

The first robot 41 may comprise a drive source 42 such as a motor (see FIGS. 1 and 3), and a slider 43 (see FIGS. 1 and 3) that moves along the movement guide 33.

An example of the drive source 42 may comprise a motor such as linear motors or a server motor.

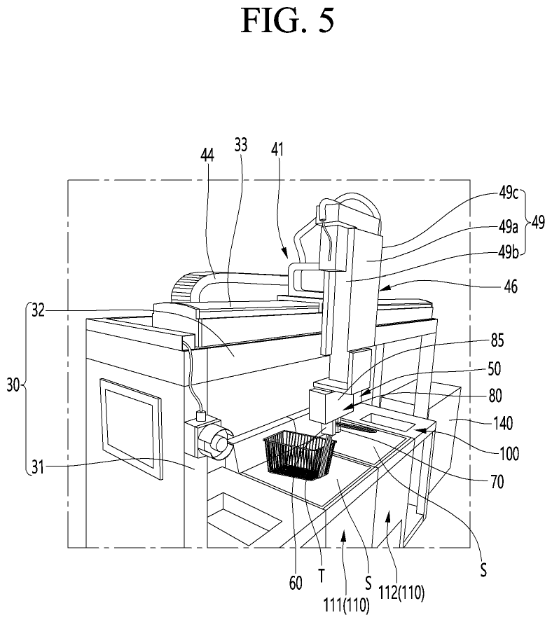

The first robot 31 may further comprise a power transmission member 44 (see FIG. 5) connecting the drive source 42 to the slider 43. The power transmission member 44 may comprise a linear guide connected to the drive source 42 and the slider 43.

When the drive source 42 is driven, the linear guide may move the slider 43, and the slider 43 may be guided by the movement guide 33 to move in the longitudinal direction X of the frame 30.

The second robot 46 may be a robot that is elevated in the direction Z perpendicular to the longitudinal direction X of the frame 30 and may be a Z-axis robot.

The second robot 46 may comprise a motor 47 (see FIG. 1), a robot body 48, and a ball screw (not shown) connected to the motor 47.

An example of the motor 47 may be a servo motor. The motor 47 may be mounted on the robot body 48.

The ball screw may be connected to the motor 47 to convert rotational movement of the motor 47 into linear movement of the gripper 50.

The ball screw may comprise a screw connected to the motor 47 and having a male screw disposed on an outer circumference thereof and a screw body on which a female screw engaged with the male screw is disposed on an inner circumference thereof. The screw body may be connected directly to the first robot 41 or may be connected to the first robot 41 through a separate connector.

The gripper 50 may be connected to the robotic mechanism 40. The gripper 50 may be connected to the second robot 46, may move in the longitudinal direction X of the frame 30 together with the second robot 46, and may be elevated in the vertical direction Z together with the second robot 46.

The gripper 50 may grip the bent portion 29 (see FIG. 4) and also may grip the extension portion 28 so that sliding of the extension portion 28 (see FIG. 4) is minimized.

The preparation table 90 may be disposed on frame 30. A space may be defined in the preparation table 90 to accommodate the body 28 of the cooking tool T. The preparation table 90 may be provided as an assembly of a plurality of members.

An auxiliary table 92 (see FIG. 2) may be provided around the preparation table 90.

The auxiliary table 92 may be a table on which a user fries the ingredients such as the raw chicken or potatoes, and frying powder is applied to the ingredients. The auxiliary table 92 may be disposed next to the preparation table 90.

The completion table 100 may be disposed on the frame 30 so as to be spaced apart from the preparation table 90. A space may be defined in the completion table 100 to accommodate the body 28 of the cooking tool T. The completion table 100 may be provided as an assembly of a plurality of members.

A sensor 102 capable of sensing the cooking tool T may be disposed on the completion table 100, and when the robot mechanism 40 moves the cooking tool T to the completion table 100, the sensor 102 may sense the cooking tool T.

A packaging table 104 may be disposed around the completion table 100.

The packaging table 104 may be a table on which an operator packages cooked food.

The fryer 110 may be disposed between the preparation table 90 and the completion table 100. A space S may be defined in the fryer 110 into which the body 28 of the cooking tool T is inserted. At least one fryer 110 may be provided, and the plurality of fryers 110 may be disposed between the preparation table 90 and the completion table 100.

The oil may be contained in the space S defined in the fryer 110, and a heating unit of the fryer 110 may heat the oil.

The plurality of fryers 111 and 112 may be disposed in a row between the preparation table 90 and the completion table 100. The preparation table 90, the plurality of fryers 111 and 112, and the completion table 100 may be disposed in a row in the longitudinal direction X of the frame 30.

The frying robot 100a may further comprise a fence 114 (see FIG. 2) disposed to be elongated along the preparation table 90, the at least one fryer 110, and the completion table 100.

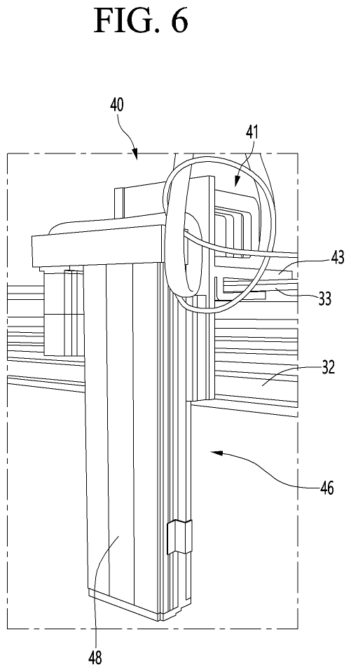

FIG. 5 is a view when the frying robot carries the cooking tool according to the present embodiment, and FIG. 6 is a perspective view illustrating the inside of the second robot according to the present embodiment.

The second robot 46 may comprise an outer cover 49 (see FIG. 5).

The outer cover 49 may define an outer appearance of the second robot 46 and protect internal components of the second robot 46.

The outer cover 49 may be mounted on the robot body 48 to cover the ball screw, etc.

The outer cover 49 may comprise a center body 49a, a front body 49b bent from a front end of the center body 49a, and a rear body 49c bent from a rear end of the center body 49a.

Scratches that may occur on an outer surface of the robot body 48 may be minimized by the outer cover 49.

As illustrated in FIG. 5, the gripper 50 may comprise a pair of fingers 60 and 70 and a finger-driving mechanism 80.

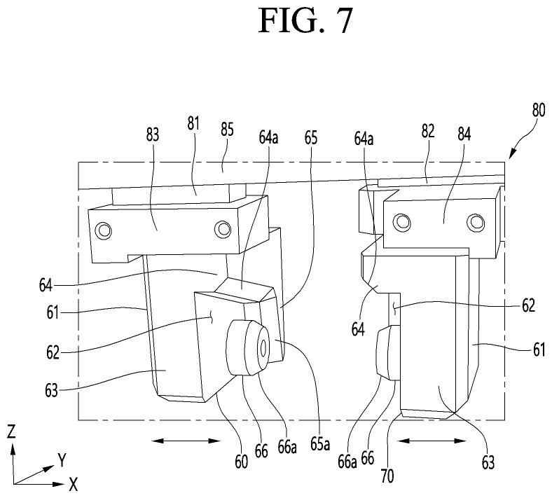

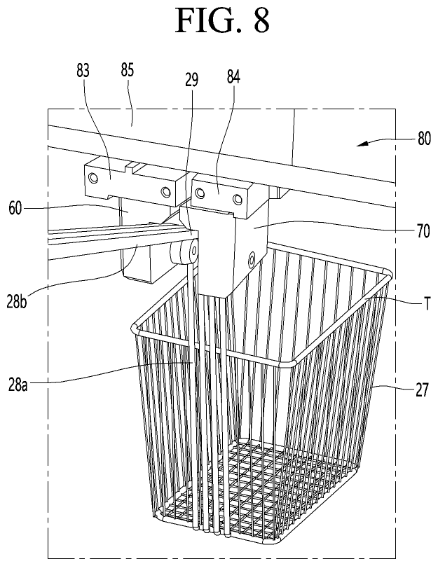

FIG. 7 is a perspective view before the gripper grips the cooking tool according to the present embodiment, and FIG. 8 is a perspective view when the gripper completely grips the cooking tool according to the present embodiment.

The pair of fingers 60 and 70 may grip the extension portion 28 of the cooking tool T. The pair of fingers 60 and 70 may move by the finger-driving mechanism 80. The pair of fingers 60 and 70 may move in a direction closer to each other to grip the cooking tool T, as illustrated in FIG. 7. The pair of fingers 60 and 70 may move away from each other and be separated from the cooking tool T, as illustrated in FIG. 6.

The pair of fingers 60 and 70 may be configured symmetrically. The pair of fingers 60 and 70 may be configured to be symmetrical to each other in the forward and backward direction.

At least one of the pair of fingers 60 and 70 may comprise a finger body 61 and a fixing guide 66.

The finger body 61 may be provided with an insertion groove portion 62 into which the bent portion 29 of the extension portion 28 is inserted.

The finger body 61 may comprise a main body portion 63, an upper body portion 64, and a side body portion 65.

The upper body portion 64 may protrude from an upper portion of the main body portion 63 and may be spaced apart from the fixing guide 66 in the vertical direction Z. An upper chamfer 64a that assists the insertion of the bent portion 29 may be provided on the upper body portion 64.

The side body portion 65 may protrude from the main body portion 63 and may be spaced apart from the fixing guide 66 in the left and right direction Y. A side chamfer 65a that assists the insertion of the bent portion 29 may be provided on the side body portion 65.

The fixing guide 66 may protrude from the insertion groove portion 62 to support the bent portion 29.

The fixing guide 66 may protrude from the main body portion 63. The fixing guide 66 may be provided in a cylindrical shape. A lower chamfer 66a that assists the insertion of the bent portion 29 may be provided on the fixing guide 66.

The insertion groove portion 62 of any one 60 of the pair of fingers 60 and 70 and the insertion groove portion 62 of the other one 70 of the pair of fingers 60 and 70 may face each other, and the bent portion 29 of the cooking tool T may be inserted into the insertion groove 62 of each of the pair of fingers 60 and 70 when the pair of fingers 60 and 70 move closer to each other.

When the bent portion 29 is inserted into the insertion groove portion 62 of each of the pair of fingers 60 and 70, an upper portion 29a of the bent portion 29 may be inserted between the upper body portion 64 and the fixing guide 66, and the upper chamfer 64a and the lower chamfer 66a may assist the upper portion 29a of the bent portion 29 to be inserted into the insertion groove portion 62.

When the bent portion 29 is inserted into the insertion groove portion 62 of each of the pair of fingers 60 and 70, a lower portion 29a of the bent portion 29 may be inserted between the side body portion 64 and the fixing guide 66, and the side chamfer 65a and the lower chamfer 66a may assist the lower portion 29a of the bent portion 29 to be inserted into the insertion groove portion 62.

The finger-driving mechanism 80 may move the pair of fingers 60 and 70 in a direction closer to each other, as illustrated in FIG. 7, and may move the pair of fingers 60 and 70 in a direction away from each other, as illustrated in FIG. 6.

The finger-driving mechanism 80 may be connected to the second robot 46.

As illustrated in FIG. 6, the finger-driving mechanism 80 may comprise a pair of moving shafts 81 and 82, a first finger bracket 83, and a second finger bracket 84.

The pair of moving shafts 81 and 82 may be spaced apart from each other in the longitudinal direction X of the frame.

The first finger bracket 83 may be connected to one 81 of the pair of moving shafts 81 and 82 and one 60 of the pair of fingers 60 and 70.

One 60 of the pair of fingers 60 and 70 may be coupled to the first finger bracket 83 through a coupling member such as a screw.

The second finger bracket 84 may be connected to the other one 82 of the pair of moving shafts 81 and 82 and the other one 70 of the pair of fingers 60 and 70.

The other one 70 of the pair of fingers 60 and 70 may be coupled to the second finger bracket 84 through a coupling member such as a screw.

The finger-driving mechanism 80 may further comprise a driver housing 85 connected to a lower portion of the second robot 46.

A pair of moving shafts 81 and 82 may be movably disposed on a lower portion of the driver housing 85.

A first advance/retract mechanism (not shown) that moves one 81 of the pair of moving shafts 81 and 82, and a second advance/retract mechanism (not shown) that moves the other one 82 of the pair of moving shafts 81 and 82 may be disposed inside the driver housing 85.

The first advance/retract mechanism may comprise a first drive source such as a motor, and a power transmission member connecting any one 81 of the pair of moving shafts 81 and 82 to the first drive source.

The second advance/retract mechanism may comprise a second drive source such as a motor, and a power transmission member connecting the other one 82 of the pair of moving shafts 81 and 82 to the second drive source.

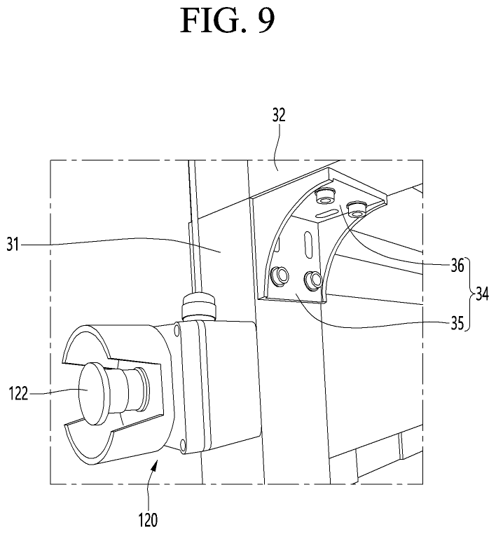

FIG. 9 is a perspective view of a frame according to the present embodiment.

The frame 30 may comprise reinforcement brackets 34 that are respectively coupled to a vertical frame 31 and a horizontal frame 32.

The reinforcement bracket 34 may comprise a vertical portion 35 coupled to the vertical frame 31 through a coupling member such as a screw, and a vertical portion 36 coupled to the horizontal frame 32 through a coupling member such as a screw.

The reinforcement brackets 34 may be provided in plurality.

The frying robot may further comprise an emergency switch 120 that stops the robot mechanism 40. The emergency switch 120 may comprise a button 122 pressed or turned by the user.

When the user presses or turns the button 122 of the emergency switch 120, power supplied from a power supply of the frying robot 10a to the robot mechanism 40 may be cut off, and the user may respond to an emergency situation.

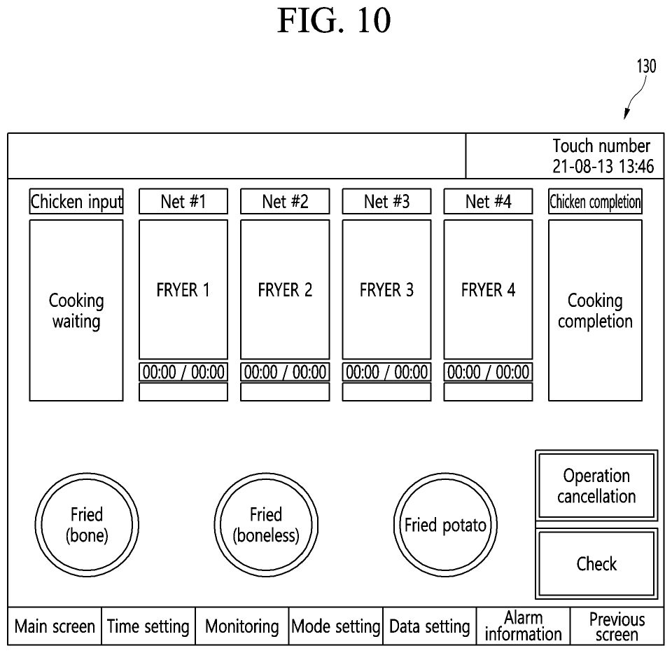

FIG. 10 is a view of a display according to the present embodiment.

The frying robot 10a may further comprise a display 130 that displays a cooking time of the fryer 110 in progress.

The display 130 may be disposed on a front or side surface of the frame 30.

The display 130 may display fryers 110 in progress of cooking and may display a remaining cooking time of each fryer 110.

The display 130 may display a bone-in fried food selection menu, a boneless fried food selection menu, a menu of deep-fried food, etc.

The user may input the fryer to be cooked, selection of the cooking menu, operation cancellation, lock, etc. through the display 130, and may check the fryer in progress of cooking, the selected cooking menu, the operation cancellation, the lock, etc. through the display 130.

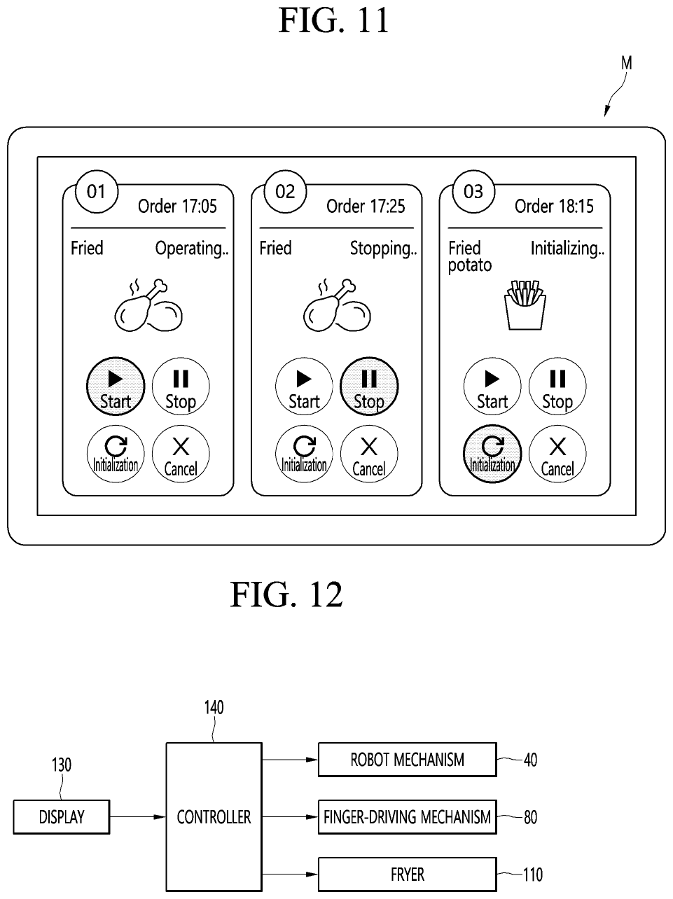

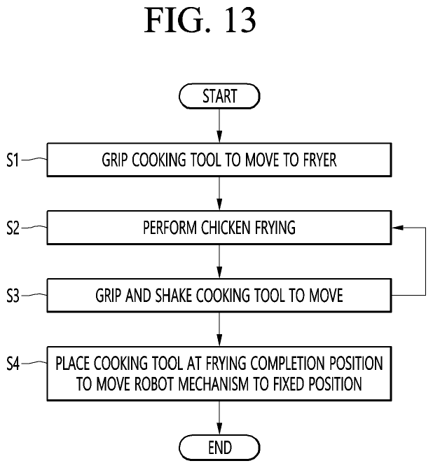

FIG. 11 is a view of a terminal according to the present embodiment, FIG. 12 is a control block diagram according to the present embodiment, and FIG. 13 is a flowchart illustrating an operation of a frying robot according to the present embodiment.

The frying robot 10a may further comprise a terminal M such as a tablet. The terminal M may be connected to a controller 140 through a communication means such as Wi-Fi.

The terminal M such as a tablet may provide an order sequence and an order time, display menu names, operation status, and menu images, and provide operation manipulation buttons for start/stop/reset/delete.

The user may check the order sequence, the order time, the menu names, the operation status, and menu for inputting an operation command of the frying robot 10a through the operation manipulation button.

The frying robot may further comprise a controller 140. The controller 140 may control the robot mechanism 40, the finger-driving mechanism 80, and the fryer 110.

The controller 140 may control the robot mechanism 40 so that the cooking tool Tis shaken at least once during the cooking by the fryer 110.

The frying robot 10a may grip the cooking tool T disposed on the preparation table 90 and then insert a net of the cooking tool T into the space S of the fryer 110. (S1)

After the net 27 of the cooking tool T is inserted into the space S2 of the fryer 110, the fryer 110 may perform cooking (frying). (S2)

When a set time has elapsed while the fryer 110 is frying ingredients contained in the net 27, the frying robot 10a may grip a bent portion 29 of the cooking tool T to shake the net 27 at least once. (S3)

The frying robot 10a may shake the net 27 at least once, and when a completion set time is reached, the frying robot 10a may control a robot mechanism 40 so that the net 27 is disposed on a completion table 100, control the robot mechanism 40 and a finger-driving mechanism 80 so that the net 27 is disposed on the completion table 100, and move the robot mechanism 40 to a fixed position. (S4)

The above-disclosed subject matter is to be considered illustrative, and not restrictive, and the appended claims are intended to cover all such modifications, enhancements, and other embodiments, which fall within the true spirit and scope of the present invention.

Thus, the embodiment of the present invention is to be considered illustrative, and not restrictive, and the technical spirit of the present invention is not limited to the foregoing embodiment.

Therefore, the scope of the present invention is defined not by the detailed description of the invention but by the appended claims, and all differences within the scope will be construed as being comprised in the present invention.

1. A frying robot comprising:
a frame;
a robot mechanism installed on the frame; and
a gripper connected to the robot mechanism,
wherein the gripper comprises:
a pair of fingers configured to grip an extension portion of a cooking tool;
a finger-driving mechanism configured to move the pair of fingers in a direction close to or away from each other,
wherein at least one of the pair of fingers comprises:
a finger body having an insertion groove portion defined therein, into which a bent portion of the extension portion is inserted; and
a fixing guide protruding from the insertion groove portion to support the bent portion.

2. The frying robot according to claim 1, wherein the finger body comprises:
a main body portion;
an upper body portion protruding from an upper portion of the main body portion and spaced apart from the fixing guide in a vertical direction; and
a side body portion protruding from the main body portion and spaced apart from the fixing guide in a left and right direction.

3. The frying robot according to claim 1, wherein an upper chamfer configured to assist an insertion of the bent portion is provided on the upper body portion.

4. The frying robot according to claim 3, wherein the fixing guide protrudes from the main body portion.

5. The frying robot according to claim 1, wherein a lower chamfer configured to assist an insertion of the bent portion is provided on the fixing guide.

6. The frying robot according to claim 1, wherein the finger-driving mechanism comprises:
a pair of moving shafts;
a first finger bracket connected to one of the pair of moving shafts and one of the pair of fingers; and
a second finger bracket connected to the other one of the pair of moving shafts and the other one of the pair of fingers.

7. The frying robot according to claim 1, wherein the robot mechanism comprises:
a first robot moving along the frame; and
a second robot disposed to be elevatable on the first robot,
wherein the finger-driving mechanism is connected to the second robot.

8. The frying robot according to claim 1, wherein the second robot comprises:
a motor;
a ball screw connected to the motor; and
an outer cover configured to cover the ball screw.

9. The frying robot according to claim 1, wherein the outer cover comprises:
a center body;
a front body bent from a front end of the center body; and
a rear body bent from a rear end of the center body.

10. The frying robot according to claim 1, wherein the frame comprises:
a vertical frame;
a horizontal frame disposed above the vertical frame; and
a reinforcement bracket coupled to each of the vertical frame and the horizontal frame.

11. The frying robot according to claim 1, wherein a moving guide configured to guide movement of the robot mechanism is disposed on the horizontal frame.

12. The frying robot according to claim 1, further comprising:
a preparation table disposed on the frame to accommodate a body of the cooking tool;
a completion table disposed on the frame to be spaced apart from the first table and configured to accommodate the body of the cooking tool; and
at least one fryer disposed between the preparation table and the completion table and having a space into which the body of the cooking tool is inserted.

13. The frying robot according to claim 12, further comprising an emergency switch configured to stop the robot mechanism.

14. The frying robot according to claim 12, further comprising a display configured to display a cooking time of the fryer in progress.

15. The frying robot according to claim 12, further comprising a controller configured to control the robot mechanism, the finger-driving mechanism, and the fryer,
wherein the controller is configured to control the robot mechanism so that the cooking tool is shaken at least once during the cooking by the fryer.

16. A frying robot comprising:
a pair of fingers configured to grip an extension portion of a cooking tool;
a finger-driving mechanism configured to move the pair of fingers in a direction close to or away from each other,
wherein at least one of the pair of fingers comprises:
a finger body having an insertion groove portion defined therein, into which a bent portion of the extension portion is inserted; and
a fixing guide protruding from the insertion groove portion to support the bent portion.

17. The frying robot according to claim 16, wherein the finger body comprises:
a main body portion;
an upper body portion protruding from an upper portion of the main body portion and spaced apart from the fixing guide in a vertical direction; and
a side body portion protruding from the main body portion and spaced apart from the fixing guide in a left and right direction.

18. The frying robot according to claim 1, wherein an upper chamfer configured to assist an insertion of the bent portion is provided on the upper body portion.

19. The frying robot according to claim 3, wherein the fixing guide protrudes from the main body portion.

20. The frying robot according to claim 1, wherein a lower chamfer configured to assist an insertion of the bent portion is provided on the fixing guide.
